(19) United States
(12) Patent Application Publication
(10) Pub. No.: US 2024/0147557 A1
(43) Pub. Date: May 2, 2024

(54) Communication Device and Method for Sustaining Ultra-Reliable Communication in Wireless Communication Network

(71) Applicant: Telefonaktiebolaget LM Ericsson (publ), Stockholm (SE)

(72) Inventors: Bipin Balakrishnan, Kävlinge (SE); Fredrik Dahlgren, Lund (SE); Ashkan Kalantari, Malmö (SE); Saeed Bastani, Dalby (SE)

(21) Appl. No.: 18/281,468

(22) PCT Filed: Mar. 15, 2021
(86) PCT No.: PCT/EP2021/056509

§ 371 Date: Sep. 11, 2023

(51) Int. Cl. H04W 76/15; H04B 7/15; H04W 76/14

(52) U.S. Cl. CPC H04W 76/15; H04B 7/15; H04W 76/14

(57) ABSTRACT

A first communication device and method therein for operating in a wireless communication network as a relay node are disclosed. The wireless communication network comprises a network node providing a coverage area and at least two mobile communication devices. The first communication device receiving (510) a request from the network node to function as a relay node for a second communication device and enters (520) into a relay mode operation. The first communication device sets up (530) a relay link comprising a first communication link between the first communication device and the network node and a second communication link between the first communication device and the second communication device and relays (540) communications between the network node and the second communication device via the relay link. In the relay mode operation, at least one of the mobility and functionality of the first communication device in a normal mode operation is controllable to prioritize the relaying function.

### TECHNICAL FIELD

Embodiments herein relate to a communication device and method therein for sustaining an ultra-reliable communication. In particular, they relate to a communication device acting as a relay node and method therein for sustaining an ultra-reliable communication for a wireless communication device in a wireless communication network.

### BACKGROUND

Wireless communication networks, such as Global System for Mobile Communications (GSM) networks, Wideband Code Division Multiple Access (WCDMA) or High Speed Packet Access (HSPA) networks, 3G Long Term Evolution (LTE) networks, Worldwide interoperability for Microwave Access (Wimax) network, Wireless Local Area Network (WLAN/Wi-Fi), LTE advanced or Fourth Generation (4G) networks, and Fifth Generation (5G) New Radio (NR) networks, usually cover a geographical area which is divided into cell areas. Each cell area is served by a base station, which may also be referred as a Network (NW) node, eNodeB (eNB), gNodeB, an access node etc. A wireless communication network may include a number of cells that can support communications for a number of wireless communication devices or User Equipment (UE). Each cell or NW node may use certain carrier frequencies and cover certain system bandwidth. The NW node serves a wireless communication device via a wireless communication link, which may also be refereed as a radio channel.

Wireless communication in higher frequency bands such as Frequency Range 2 (FR2) including frequency bands from 24.25 GHz to 52.6 GHz, are sensitive to obstacles that might limit the radio channel causing disruptions in the communication between a UE and a base station. Ultra-Reliable Low-Latency Communication (URLLC) applies to applications demanding real-time services that cannot be disrupted. Device-2-device (D2D) enables communication directly between UEs. D2D-based relay has been proposed to enable multi-hop, e.g. from UE A to UE B and from UE B to base station (UEA-UEB-Base station), communication to overcome temporary blocking of the radio channel between UE A and the base station.

Most of the existing solutions involving relays are to improve performance of a communication network and often based on fixed location relays. The ones that cover dynamic mobile relays, such as in R. Ibrahim, et. al., “A Dynamic and Incentive Policy for Selecting D2D Mobile Relays” Computing Research Repository (CoRR) in arXiv, 2019, are focusing on the trade-offs between performance enhancement, e.g. throughput, reliability, coverage, versus costs e.g. power budget, transmission power, and not prioritizing the requirement of maintaining a sustained communication link to support the ultra-reliability (UR) aspects of URLLC applications.

### SUMMARY

As part of developing embodiments herein a problem was identified and will first be discussed.

The pre-art solutions do not consider reliability as packet success rate within a bounded latency, which is the case for applications that belong to URLLC use-case type. When using dynamic mobile relays, devices are mobile, and the circumstances may change. For example, a mobile relay may enter into a non-coverage region of a network node along with a device it is serving, hereafter refereed as a client device, then the communication between the mobile relay and the network node may be disrupted, and the communication between the client device and the network node via the mobile relay is also disrupted. The prior art, therefore, do not provide a reliable solution for scenarios when devices are moving, and the circumstances change.

It is therefore an object of embodiments herein to provide an improved technique for sustaining an ultra-reliable communication in a wireless communication network for devices requiring a high communication link quality e.g. URLLC.

According to a first aspect of embodiments herein, the object is achieved by a method performed in a first communication device operating in a wireless communication network as a relay node. The wireless communication network comprises a network node providing a coverage area and at least two mobile communication devices.

The first communication device receives a request from the network node to function as a relay node for a second communication device and enters into a relay mode operation.

The first communication device sets up a relay link comprising a first communication link between the first communication device and the network node and a second communication link between the first communication device and the second communication device.

The first communication device relays communications between the network node and the second communication device via the relay link.

In the relay mode operation, at least one of the mobility and functionality of the first communication device in a normal mode operation is controllable to prioritize the relaying function.

To prioritize the relaying function, the first communication device may perform any one or a combination of the following actions: reserving resources within the first communication device to perform the relaying function, releasing one or more of the other communication links, releasing one or more of the other communication activities, releasing one or more of data processing activities, enabling specific hardware capabilities such as hardware acceleration if such capabilities exist, changing beam direction, adapting beam selection, adapting security within the first communication device etc.

According to some embodiments herein, the movement and/or velocity of the first communication device may be controllable and the first communication device may adjust its position and/or velocity so that the quality of the first and second communication links meet a required threshold.

In other words, according to embodiments herein, a communication device is requested to operate in a relay mode for one or more other communication devices, i.e. one or more client devices, whose communication to the network node has higher priority and the quality of the communication link to the network node of the one or more client devices does not or will not meet a required threshold. The appointed communication device supports the relay node functionality to ensure a sustained communication link to the one or more client devices. The relay node functionality involves signaling to the network node and to each other, such as to achieve efficient handover so that there is only a max of 2 relay nodes between a client device and a network node and after handover period there is only one relay link in addition to the direct link to the network node, which may be partially or fully blocked.

One of the principles to secure ultra-reliable communication according to embodiments herein is that a communication device which is in a coverage area of a network node is appointed as a relay node to maintain the communication link for a client communication device it is serving, when the client device is moving into and out of the coverage area of the network node. In order to secure that the communication device it is serving always has a coverage, the mobility of the communication device acting as a relay node may be controllable. In other words, the communication device acting as a relay node may position itself in a location, or temporarily restrict its further movements so that it can provide a sustained communication link to the communication device that needs sustained communication link. The communication device acting as a relay node thus may prioritize, at least temporarily, the relay function over its own normal communication device functionality. Further handover between relay nodes in coverage region may be performed to secure ultra-reliable communication.

The embodiments herein ensure wireless communication devices requiring Ultra-Reliable Communication (URC) such as URC or URLLC applications in industrial fleet driving, Automated guided vehicle (AGV) etc., are in coverage and have always a communication link in such an environment where the wireless communication devices are mobile.

The embodiments herein minimize power and resource overhead for reliability enhancement using a limited number of relay nodes, for example 1 or at most 2 relay nodes dependent on scenario and impact on latency. Latency may also be reduced by using relay node, for example, if a client device experiences too much packet loss and hence needs retransmissions due to obstruction which leads to increased latency experienced per packet, then using relay node may reduce latency or control upper bound latency.

Therefore, the embodiments herein provide an improved method and apparatus for sustaining an ultra-reliable communication for critical applications that fall into URLLC use-case type.

### BRIEF DESCRIPTION OF THE DRAWINGS

Examples of embodiments herein are described in more detail with reference to attached drawings in which:

FIG. 1 is a schematic block diagram illustrating embodiments of a wireless communication network in which embodiments herein may be implemented;

FIG. 2 is an example signaling chart according to embodiments herein;

FIG. 3 is a flow chart illustrating exemplary steps which may be performed by a relay node according to embodiments herein;

FIG. 4 is a flow chart elaborating further functions in a relay node during the relay mode operation according to embodiments herein;

FIG. 5 is a flowchart depicting one embodiment of a method in a communication device according to embodiments herein; and

FIG. 6 is a schematic block diagram illustrating an example embodiment of a communication device.

### DETAILED DESCRIPTION

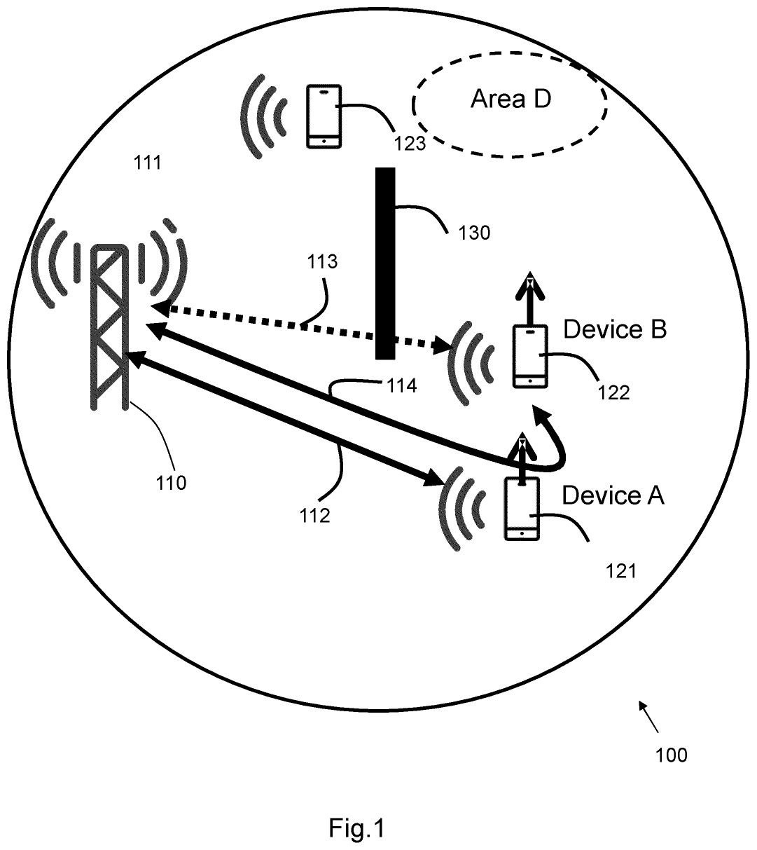

FIG. 1 illustrates an example scenario in a wireless communications network 100, where a communication link between a mobile device and a network node may be blocked. The wireless communication network 100 may be any wireless system or cellular network, such as a LTE network, any 3GPP cellular network, Wimax network, WLAN/Wi-Fi, an LTE advanced or 4G network, a 5G or NR network etc.

The wireless communication network 100 comprises a plurality of network nodes whereof a network node 110 has a coverage area, indicated by a cell 111 is depicted in FIG. 1. The network node 110 is a network access node which may be a base station (BS), for example, an eNB, gNB, eNodeB, gNodeB, or a Home NodeB, or a Home eNodeB or a Home gNodeB. For the sake of easier understanding by the reader, the term “cell” has been used above. However, spatial division between operation areas of a network node may be based on other entities, such as sectors, beams, etc. Sectors are statically defined directions from an antenna of the network node and beams are dynamically defined directions from an antenna of the network node. Thus, for any disclosure herein where the term “cell” is used, the demonstrated principles are equally feasible for sectors, beams, etc., unless explicitly or implicitly expressed otherwise.

Multiple communication devices operate in the wireless communication network 100, whereof a first communication device 121, Device A, a second communication device 122, Device B, and a third communication device 123, are depicted in FIG. 1. The communication device 121, 122, 123 may be any type of device with wireless communication capabilities, such as a UE, modem, an Internet of Things (IoT) device, an MTC device, a mobile wireless terminal or a mobile phone, a smartphone, or any other radio network unit capable to communicate over a radio link in a wireless communication network.

As shown in FIG. 1, the two wireless communication devices, the first and second communication devices, Device A and Device B, are moving in the directions indicated by the black lines with single arrow. Device B requires ultra-reliable communication with the network node 110, and at radio frequencies e.g. FR2, which can be obstructed by walls or obstacles indicated by a black bar 130. Device A has a communication link with the network node 110, indicated by an arrow line 112, and may be a potential relay node for Device B via Device to Device (D2D) communication. As illustrated in the FIG. 1, Device B has moved behind the wall 130, which may be refereed as a radio shadow region, so its direct link to the network node 110, indicated by a dashed arrow line 113, is no longer reliable or even useful, so it now communicates via the relay link through Device A, indicated by an arrow line 114.

The proposed solutions according to embodiments herein handle the dynamics of such a network when devices are moving, and the scenario is dynamically changing. As the second communication device Device B is now dependent on Device A for its communication until it reaches an area where it can restore its direct link to the network node 110, the network node 110 may direct the first communication device Device A to not yet move behind the wall 130 so it may also lose its connection until Device B has reached an area where reconnection is achieved. Hence, the movements of the communication device Device A may be restricted so that it can continue to support Device B or even proactive in that it moves in a way that it can continuously support Device B until either Device B has good coverage or another relay node takes over.

A relay node is a node that is capable and willing to act as a relay to enable a communication between another device and the network node via the relay node. In FIG. 1, the first communication device Device A is an appointed relay node for Device B, and the critical communication traffic is now going via the first communication device Device A as long as Device B does not have a direct link to the network node 110. When Device B proceeds into “Area D” indicated by dotted oval in the figure, the traffic of Device B will be handed over to a direct link between it and the network node 110.

The principle of embodiments herein for an ultra-reliable communication is based on the following concepts:
The network node can restrict the movement of an appointed relay node, e.g. Device A, for the client device, Device B, to guarantee non-disrupted communication. Thus, the appointed relay node positions itself in a location so as to guarantee the sustained communication link to the client device and also sustained communication link to the network node 110.
Dynamically enabling a communication device as relay nodes depending on their real-time demands, e.g. ability to have its mobility restricted, besides their position, capabilities, and others. Once the relay node functionality is enabled, this relaying function may take precedence over the normal function of the appointed relay node.

According to some embodiments herein, the network node may create a group of candidate relay nodes comprising one or more communication devices which are in the coverage area of the network node and have capability and willingness to support relay node functionality.

The network node may assess prioritizations among the group of the candidate relay nodes. The network node may determine a first communication device as a relay node out of the group of the candidate relay nodes based on the assessed prioritizations. The network node may evaluate characteristics of the wireless communication devices which are in the group of candidate relay nodes to assess the prioritizations. The characteristics of the wireless communication devices may include e.g. communication channel quality of the communication devices to the network node, capabilities of the communication devices; battery status of the communication devices; ongoing communication activities of the communication devices; projected movements of the communication devices; time schedule slacks of the communication devices, serving time thresholds of the communication devices indicating during which they can serve as a relay node, etc.

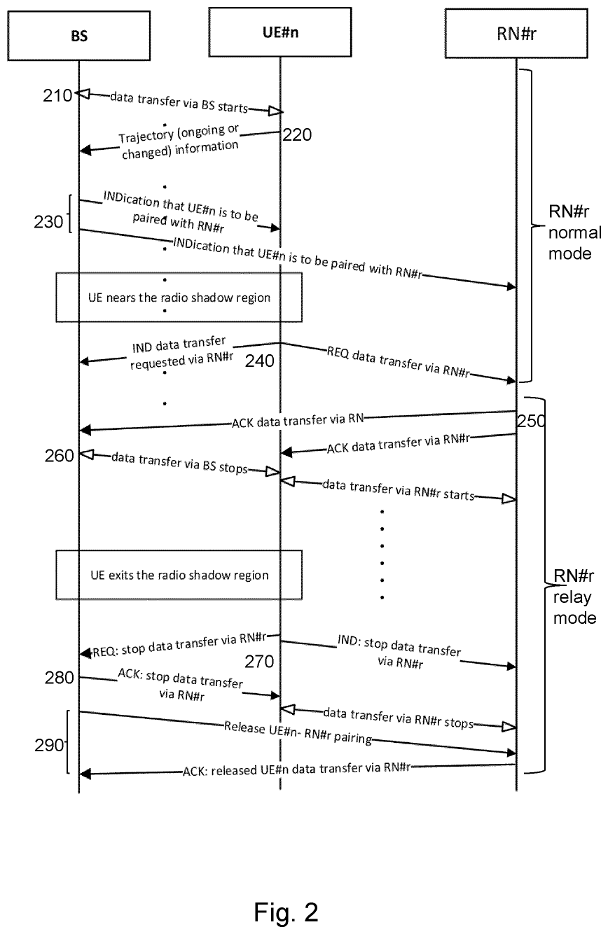

FIG. 2 is a signaling chart illustrating exemplary steps which may be implemented for the signaling between the network node 110 shown as a base station (BS), the first communication device 121 shown as a relay node (RN #r) and the second communication device 122 shown as a client device (UE #n), to handle communication between the network node 110, the first communication device 121 and the second communication device 122, for appointing and controlling relay nodes and handover traffics e.g. data transfer, between the direct link and relay link.

Step 210: Data transfer starts over the direct link between the network node BS and the client device UE #n.

Step 220: The client device UE #n sends ongoing or changed trajectory information to the network node BS.

Step 230: The network node BS sends an indication to the client device UE #n to indicate that the client device UE #n is to be paired with the relay node RN #r. The network node BS also sends an indication to the relay node RN #r to indicate that the client device UE #n is to be paired with the relay node RN #r. The network node BS allocates resources for the UE #n to contact RN #r.

Step 240: When the client device UE #n nears a radio shadow region, it sends an indication to the network node BS to request data transfer via the relay node RN #r. The client device UE #n also sends a request to the relay node RN #r to request data transfer via the relay node RN #r.

Step 250: The relay node RN #r sends an ACK message to the network node BS and to the client device UE #n to indicate that the data transfer request via relay is acknowledged. The RN #r enters into a relay mode operation, i.e. a “restricted mode” which means that the relay operation is prioritized over its data transmission in normal mode.

Step 260: The network node BS allocates resources for the client device UE #n to carry out data transmission via the relay node RN #r. Data transfer via the network node BS stops and data transfer via the relay node RN #r starts.

Step 270: When the client device UE #n exits the current radio shadow region and is sufficiently distant from the next radio shadow region, it requests to stop data transfer via the relay node as the network node BS needs to release the resources. The client device UE #n sends a request to the network node BS to stop data transfer via the relay node RN #r and sends an indication to the relay node RN #r to stop data transfer via the relay node RN #r.

Step 280: The network node BS sends an ACK message to the client device UE #n to indicate that the request to stop data transfer via the relay node is acknowledged.

In a scenario where the client device UE #n may not know if the next radio shadow region is nearby, but the network node BS knows, although the client device UE #n sends a request to stop data transfer via the relay node, the network node BS may not send an ACK message but may then maintain the existing relay node or request a new relay node. The client device UE #n is released from the communication via the relay node only when there is a possibility of continued connectivity via its direct communication link to the network node BS.

Step 290: The network node BS sends a request to the relay node RN #r to release UE #n and RN #r pairing, and the relay node sends an ACK message to the network node BS to confirm that the UE #n data transfer via RN #r is released.

This signaling chart may be used for trajectory signaling of the client device and shows how the network node BS may indicate the relay nodes in that trajectory and when those relay nodes are to be contacted via the second communication link, i.e. the sidelink between the two devices via e.g. PC5 interface.

As the client device UE #n nears the position of the relay node RN #r, it sends control signaling to the relay node and which in turn notifies the network node BS or a central entity so that the network node BS can switch the traffic and the device that acts as the relay node takes the relay function.

It should be noted that in FIG. 2, although it is shown that the network node BS pairs the RN #r and UE #n, it is UE #n's decision WHEN it should initiate the data transfer. Therefore, the UE #n sends a request (REQ) data transfer message to RN #r to indicate this. Secondly the network node BS needs to adjust the resource allocation. Therefore, UE #n also sends an indication (IND) that data transfer is requested via RN #r, which also notifies the network node BS when UE #n has initiated the request. So, this acts similar as an ACK for the initial pairing of RN #r & UE #n.

According to some embodiments herein, the client device UE #n nearing a radio shadow region may be determined by the network node BS based on other devices' measurements in that region, historical data, location, time of arrival, etc. The exiting of the client device UE #n from the radio shadow region may also be determined by the network node BS based on other devices' measurements in the region and/or historical data.

Alternatively, the UE #n may continuously measure the received signal strength from the network node BS to determine if it is back in coverage. In addition, to avoid false indication that the UE #n has moved out of the radio shadow, UE #n could filter out small regions of spotty coverage to ensure that the signal strength is consistent for some pre-defined time period. Here, UE #n could use the synchronization signal block (SS block), which consists of Primary Synchronization Signal (PSS), Secondary Synchronization Signal (SSS), and the physical broadcast channel to check if it has moved out of the radio shadow. When the network node BS uses beamforming, it sweeps through its beams and transmits SS block through each beam, which is referred to as SS burst set. The UE #n listens for each SS block and if it can decode it, it responds to the BS with the time index of the decoded SS block to indicate the best transmitting beam of the BS.

The network node BS indicates the location of the relay node RN #r to the client device UE #n so that it can know when it reaches or nears that RN #r and then be able to address it with the relay node specific address, e.g. D2D ID/address, that was also passed to the UE #n during the “UE #n pairing with RN #r” message shown in FIG. 2.

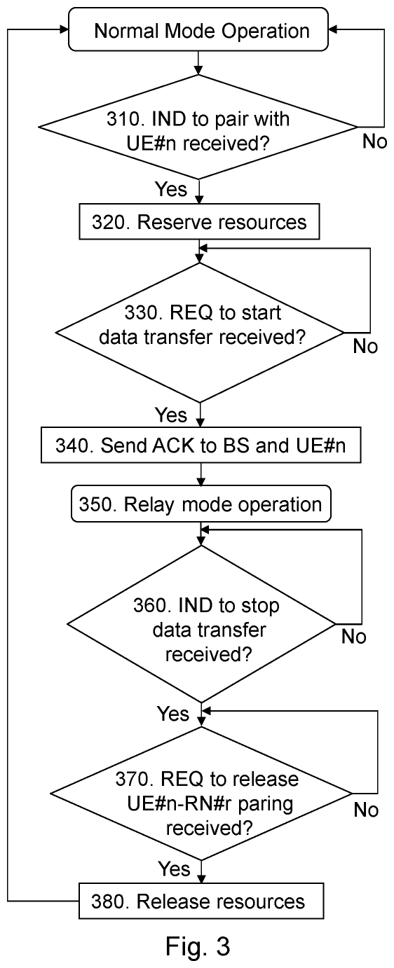

FIG. 3 depicts a flow chart illustrating exemplary steps which may be performed by a relay node, e.g. the communication device 121. FIG. 3 is corresponding to the signaling flow chart and specifically adds details to relay node behavior depicted in FIG. 2.

Step 310: The communication device 121 may check if an indication to pair with a client device UE #n is received from a network node during its normal mode operation.

Step 320: If the indication is received, the communication device 121 may reserve resources, e.g. hardware resources, processing resources etc., to prioritize the client device's communication traffic over its own traffic.

Step 330: The communication device 121 may check if a request is received from the client device UE #n to start data transfer. The request may be queued while reserving resources. An expiry timer may be used to recover from a missing request.

Step 340: If the request is received, the communication device 121 may send an acknowledge (ACK) message to the network node BS and the client device UE #n.

Step 350: The communication device 121 enters a relay mode operation, i.e. a restricted mode of operation.

Step 360: The communication device 121 may check if an indication to stop data transfer is received from the client device UE #during the relay mode operation. Alternatively, the communication device 121 may receive an indication to stop data transfer from the network node 110. In this case, the client device UE #n sends an indication to stop data transfer to the network node BS and the network node 110 then may combine the indication message with a release request and send the combined message to the communication device 121. The network node BS may also only send the indication to stop data transfer to the communication device 121.

Step 370: If an indication to stop data transfer is received, the communication device 121 may check if a request to release the paring between the communication device 121 and the client device UE #n is received from the network node BS.

Step 380: The communication device 121 releases the resources allocated for relay function and exits from the relay mode operation, returns to the normal mode operation.

The flow chart indicates one example scenario wherein the relay mode is exited after data transfer is over and by signaling and checks in steps 360 and 370. However, there are different implementations on how to exit from the relay mode operation.

According to some embodiments herein, the ACK message in Step 340 may carry an indicative time after which the communication device 121 may automatically exit the restricted mode without the signaling and checks in Steps 360 and 370. This indicative time may be a fixed time for ultra-reliable data transfer requests and may be an approximate for the best effort data transfer requests. This embodiment covers the scenario that the relay node knows upfront that it can function in the restricted mode only for a pre-defined time duration.

According to some embodiments herein, the communication device 121 may enter the relay mode operation for a pre-defined time duration. In this case the indication to stop transfer data and the release request are not expected or checked in Steps 360 and 370, and the communication device 121 automatically exits the restricted mode after the pre-defined time duration.

According to some embodiments herein, an indication to stop data transfer may be checked in Step 360 but waits a limited time to release. In this case, after the reception of the indication to stop data transfer, the relay node may set a timer and when the timer expires, it triggers the release of the resources regardless of receiving any release signal from the network node.

According to some embodiments herein, the relay node may need to exit the restricted mode by itself perhaps due to some prior unknown critical functionality that will prevent it from continuing in restricted mode. In such a case, a decision step may be added to check if there is such a critical request is received during the restricted mode operation. This decision step may be added to the “No” branches of the decision step 360 for checking the indication to stop data transfer and the decision step 370 for checking the request to release pairing. This is to be then supplemented with signaling to the client device UE #n and the network node BS to indicate this critical failure.

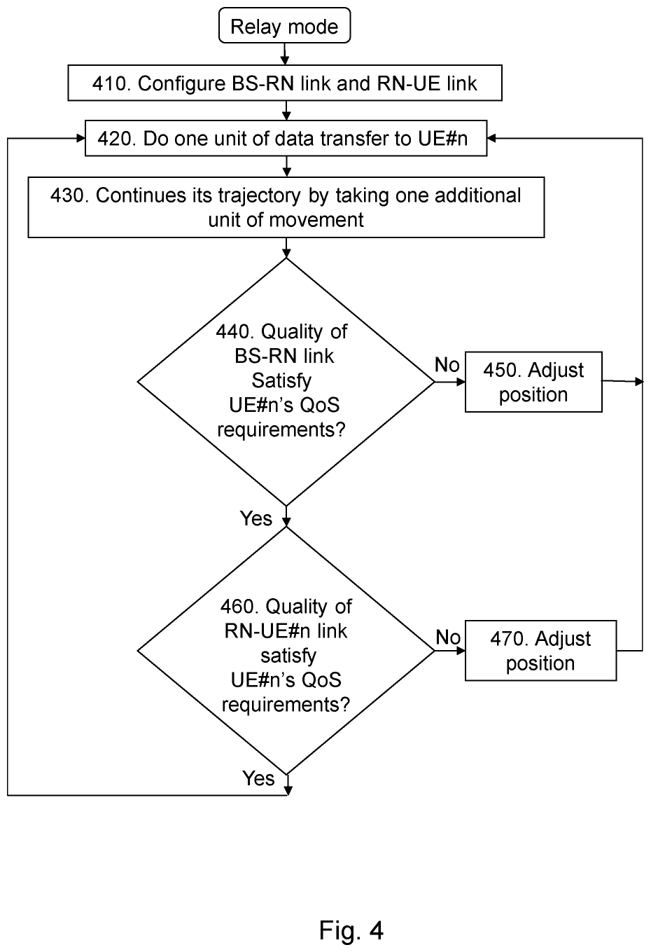

FIG. 4 is flow chart elaborating further functions in a relay node (RN) during the relay mode operation. More specifically, it depicts the scenario where the relay node is determining its best position to serve the client device UE #n by adapting to the observed behavior of the client device as well as the radio channel conditions to the network node 110. The mobility of the relay node in the normal mode operation can be controlled to prioritize the relaying function. As shown in FIG. 4, the relay node may perform the following steps during the relay mode operation.

Step 410: After entering the relay mode operation, the RN configures the BS-RN uU communication link, i.e. the link between the relay node (RN) and base station (BS), and the RN-UE #n communication link, i.e. the side-link or PC5 link between the relay node and the client device UE #n. The uU is the radio interface between the radio access network node and UE and PC5 is the radio interface between UE and UE. For examples, during the configuration, the uU interface resources such as frequency, data routes, protocol buffers, timers etc. are set up for the relay function. Similarly, for the PC5 link, in addition to the resources set up as the uU interface, it is programmed with the identity (ID) of the client device and also the data path from uU interface to/from PC5 interface is established based on the relay traffic ID. This configuration may be done before sending the ACK message to BS and UE #n's in response to UE #n's request to start the data transfer via the RN, in Step 330 of FIG. 3.

Step 420: The RN does one unit of data transfer in the relay mode to the client device UE #n along with opportunistic data transfer for its own functioning. One unit of data transfer may be one application protocol data unit (PDU) or multiple PDUs that needs to be transmitted together. This may depend on the application.

Step 430: The RN continues its trajectory by taking one additional unit of travel or movement. One unit of movement may be programmed to different granularities and may be based on the client device UE #n's application. The unit of movement may differ between different iterations of this step.

Step 440: The RN checks if the connection status of the BS-RN link, i.e. the quality of the BS-RN link, satisfies the UE #n's Quality of Service (QoS) requirements.

Step 450: If the connection status of the BS-RN link does not satisfy the UE #n's QoS requirements, the RN adjust its position to guarantee the BS-RN link satisfy the QoS requirements, e.g. to fulfil a required quality threshold.

Step 460: If the connection status of the BS-RN link satisfies the UE #n's QoS requirements, the RN checks if the connection status of the RN-UE #n PC5 link satisfies the UE #n's QoS requirements.

Step 470: If the connection status of the RN-UE #n PC5 link does not satisfy the UE #n's QoS requirements, the RN adjust its position to guarantee the PC5 link satisfy the QoS requirements, e.g. to fulfil a required quality threshold.

Adjusting the position of the RN may include triggering new measurement reports and/or statistical models to ascertain the predicted quality of the link at the future positions or fall back to the old position(s) in the recent history and/or position(s) where the historical data shows that it was possible for the link to satisfy the QoS requirements.

In case there is no good position where it is possible to lead to a satisfactory link quality, then the RN may issue a warning to the BS for the degraded data transfer to UE #n and even exit the relay mode. This decision may be taken before the next data unit needs to be transferred or depending on the application's tolerance for data gaps.

If the connection status of the RN-UE #n PC5 link satisfies the UE #n's QoS requirements, the RN can continue to perform its relay function, i.e. to perform Step 420, does one unit of data transfer in the relay mode to the client device UE #n.

The quality determination on the individual BS-RN or RN-UE #n link, i.e. uU or PC5 interface link, may be based on any existing methods. For example, if there is a deterioration in the channel quality between the client device and the network node, this should be evident from the Channel Quality Indicator (CQI) or packet re-transmissions. In some embodiments, the trajectory of the client device towards a radio shadow region may be also used to predict a poor radio link quality in the near future.

In some embodiments, the RN might re-position itself based on the link quality to the UE #n or the BS, in order to adapt so the link quality is good enough. If it discovers that it cannot maintain a good link quality to both UE #n and BS, it needs to indicate this so that a different RN can be appointed or an additional RN joins in the relay link.

In the following, other embodiments which are possible for the relay node to adjust its position are described.

According to some embodiments herein, the mobility of the relay node may be controlled or guided by the network node. If the network node has information on the trajectory of the client device UE #n as well as knowledge in signal conditions in various directions, the network node may have a good opportunity to guide the relay node to adjust its position so that the communication links BS-RN and RN-UE #n are maintained, and their quality fulfill a required threshold.

According to some embodiments herein, the mobility of the relay node may be controlled or guided by the client device UE #n: The client device UE #n may indicate its intention allowing the relay node to move in order to follow if the relay node remains in good radio channel conditions to the BS.

According to some embodiments herein, the mobility of the relay node may be controlled or guided by a combination of the BS and the client device UE #n.

According to the description above, the principle of the embodiments herein is that when a communication device enters a relay mode operation, a negotiated priority is given for the relay function rather than the communication device's own normal function and operation. There are variations on the exact implementation, however the above description is a typical scheme and anyone skilled in the art can provide alternative schemes by following the basic principle or intention of the above solutions.

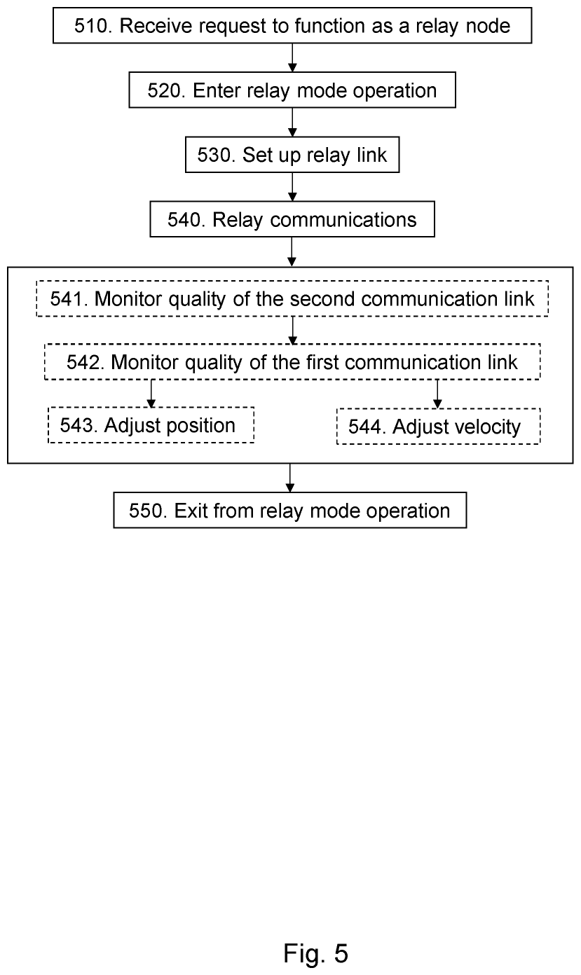

In the following, a method performed in a communication device 121, 122, 123, e.g. the first communication device 121 operating in the wireless communication network 100 as a relay node will be described with reference to FIG. 5. The method comprises the following actions which actions may be performed in any suitable order.

Action 510

The first communication device 121 receives a request from the network node 110 to function as a relay node for a second communication device 122. The request may comprise an indication to indicate which communication device UE #n that the first communication device 121 is to be paired with. The first communication device 121 usually has a normal mode operation. During the normal mode operation, the first communication device 121 checks whether a request is received from the network node 110 to pair with a client device UE #n and act as a relay node for the client device. If the first communication device 121 receives a request from the network node 110 to pair with a second communication device, i.e. the client device UE #n, it will reserve or allocate resources on e.g. hardware (HW) and central process unit (CPU) to prioritize the client UE #n's traffic over its own traffic.

To act as a relay node, at least one of the mobility and functionality of the first communication device 121 in the normal mode operation is controllable to prioritize the relaying function. According to some embodiments herein, to prioritize the relaying function, the first communication device 121 may perform any one or a combination of the following actions:
a) Reserving resources within the first communication device 121 to perform the relaying function;
b) Releasing one or more of the other communication links;
c) Releasing one or more of the other communication activities;
d) Releasing one or more of data processing activities;
e) Enabling specific hardware capabilities such as hardware acceleration if such capabilities exist;
f) changing beam direction;
g) adapting beam selection;
h) adapting security within the first communication device 121. For examples, Setting up secure enclaves such that the relayed traffic and non-relayed traffic are in separate secure domains, setting up alerts for intrusion into these enclaves, adapting to the specific data encryption mechanisms for the relay traffic etc.

The network node 110 may schedule the first communication device 121 so that the communications of the second communication device 122 is prioritized over the communications of the first communication device 121. For example, the resource scheduling may be done in such a way that the network node 110 may provide resources so that the communication needs to relay to the second device is carried out first. Then resources may be scheduled for the communication in normal operation mode of the first communication device 121 and only if these communications do not disturb the communication of the second communication device 122.

Action 520

The first communication device 121 enters into a relay mode operation. The procedure to enter the relay mode operation may comprise the following actions as described in Steps 330 and 340:

The first communication device 121 may check if a request from the second communication device to start data transfer is received. The request may be queued while reserving resources.

The first communication device 121 may send an ACK message to the network node 110 and second communication device to indicate that the request to start transfer data via relay is acknowledged. The first communication device 121 then enters into the relay mode operation.

According to some embodiments herein, an expiry timer may be set to recover from a missing request. That is if there is no request received from the second communication device within a predefined time, the first communication device 121 enters into the relay mode operation in absence of the request.

Action 530

After entering the relay mode operation, as described above in Step 410, the first communication device 121 sets up a relay link comprising a first communication link between the first communication device 121 and the network node 110 and a second communication link between the first communication device 121 and the second communication device 122.

Action 540

After the relay link is set up, the first communication device 121 relays communications between the network node 110 and the second communication device 122 via the relay link.

According to some embodiments herein, once the first communication device 121 in the relay mode operation, the first communication device 121 may be requested to be a relay node for another device e.g., a client device UE #m, which needs to have similar communication requirements as the client device UE #n. If the first communication device 121 can satisfy the requirements of the client device UE #m, it may also take it up. In other words, an additional relay functionality for a third communication device may be taken up if the current relay commitments for the second communication device 122 are not violated.

In the relay mode operation, the first communication device 121 may monitor the quality of the relay link and adjust its position to guarantee that the quality of the relay link fulfils a required threshold. Therefore, the method may further comprise the following actions:

Action 541

The first communication device 121 may monitor a quality of the second communication link and inform the network node 110 of the quality of the second communication link.

Action 542

The first communication device 121 may monitor a quality of the first communication link and inform the network node 110 of the quality of the first communication link.

Action 543

The first communication device 121 may adjust its position so that the quality of the first and second communication links meet a required quality threshold. The quality threshold for the first communication link may be greater than or equal to the quality threshold for the second communication link.

The first communication device 121 may perform the following actions to adjust its position, which are also described above with reference to FIG. 4:
taking one unit of movement;
checking the quality of the first communication link;
adjusting its position if the quality of the first communication links does not meet a required threshold;
checking the quality of the second communication link; and
adjusting its position if the quality of the second communication links does not meet a required threshold.

Action 544

The first communication device 121 may adjust its velocity to avoid entering an area where the quality of the first communication link does not or will not meet a required threshold.

According to some embodiments herein, the first communication device 121 may adjust its position and/or velocity based on any one or a combination of:
a) instructions received from the network node 110;
b) information received from the second communication device 122;
c) stored location information;
d) predicted channel quality in the moving path of the second communication device 122;
e) historic data on channel quality at different positions.

According to some embodiments herein, in a factory scenario the devices may e.g. move on rail, so the first communication device 121 may use any control protocol for that movement to adjust its position when the first communication device 121 is in the relay mode operation.

According to some embodiments herein, the first communication device 121 may receive information from the network node 110 on a better position in order to serve as a relay node for the estimated outage area of the other devices. The network node 110 may predict at which positions the second communication device 122 is likely to lose its connection and controlling the movement of the first communication device 121 based on the prediction. The network node 110 may regulate the velocity of the first communication device 121 to avoid entering an area where the communication channel quality to the network node 110 does not or will not meet a required threshold.

According to some embodiments herein, the communication device 121 may move to a place right before the other devices need relay support in the first place before the link quality became too poor.

According to some embodiments herein, in the Automatic Guided Vehicles (AGV) scenario, there may be pre-defined routes. So, the communication device 121 knows its route and schedule and could enable it to be a relay node.

According to some embodiments herein, the communication device 121 may use positioning features such as Global Positioning System (GPS) or Global Navigation Satellite Systems (GNSS) to adjust its position.

Action 550

When there is no need to act as a relay node or if it is not possible to act as a relay node anymore, the first communication device 121 exits from the relay mode operation.

As described above in Step 380, exiting from the relay node operation may be based on any one of:
a) a predefined time period to act as a relay node that is expired;
b) an instruction received from the network node 110, e.g. a signal received from the network node 100 to release from the relay mode operation;
c) an indication received from the second communication device 122, e.g. a signal received from the second communication device 122 indicating that the data transfer is over;
d) inability to function as a relay node anymore due to critical functionality that will prevent it from continuing in relay mode operation. For examples, an error situation, device malfunction or security related issues etc.

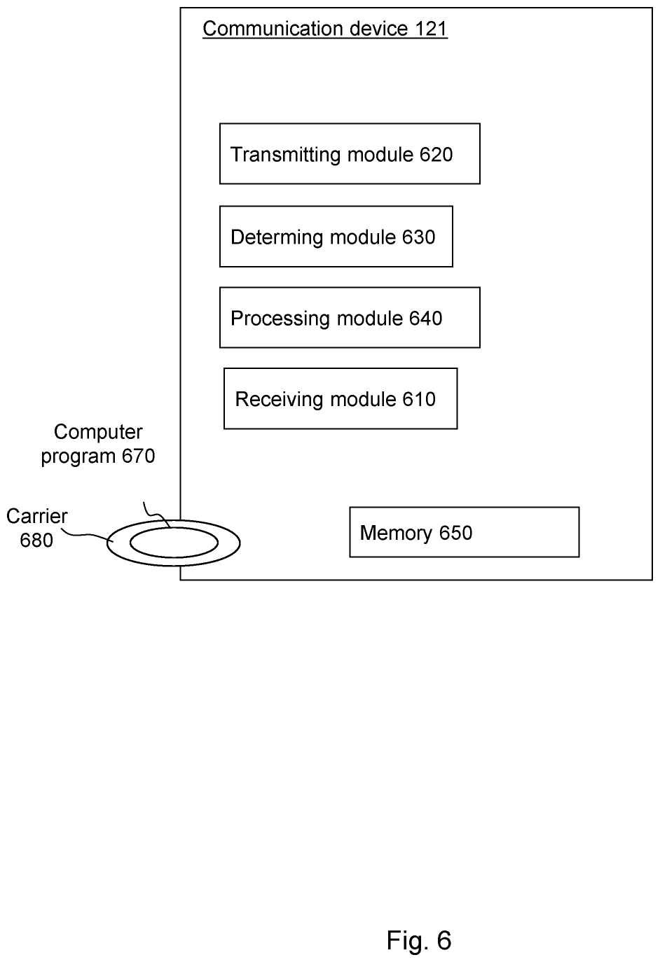

To perform the method actions in the communication device 121 for ultra-reliable communication in the wireless communication network 100 described above in relation to FIGS. 3, 4 and 5, the communication device 121 comprises circuits, modules or units as depicted in FIG. 6. The communication device 121 comprises a receiving module 610, a transmitting module 620, a determining module 630, a processing module 640, a memory 650 etc. The communication device 121 is configured to perform any one of the method actions 510-550 described above, for examples:

The communication device 121 is configured to, e.g. by means of the receiving module 610 being configured to, receive a request from the network node 110 to function as a relay node for a second communication device 122.

The communication device 121 is configured to, e.g. by means of the determining module 630 being configured to, enter into a relay mode operation.

The communication device 121 is configured to, e.g. by means of the determining module 630 being configured to, set up a relay link comprising a first communication link between the first communication device 121 and the network node 110 and a second communication link between the first communication device 121 and the second communication device 122.

The communication device 121 is configured to, e.g. by means of the receiving module 610, the transmitting module 620, and the determining module 630 being configured to, relay communications between the network node 110 and the second communication device 122 via the relay link.

The communication device 121 is configured to, e.g. by means of the determining module 630 being configured to, control at least one of the mobility and functionality of the first communication device 121 in a normal mode operation to prioritize the relaying function.

Those skilled in the art will appreciate that the receiving module 610, the transmitting module 620, the determining module 630 and the processing module 630 described above in the first communication device 121 may be referred to one circuit or unit, a combination of analog and digital circuits, one or more processors, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors in the first communication device 121 together with computer program code for performing the functions and actions of the embodiments herein. The program code mentioned above may also be provided as a computer program product, for instance in the form of a data carrier 680 carrying computer program code 670, as shown in FIG. 6, for performing the embodiments herein when being loaded into the first communication device 121. One such carrier may be in the form of a CD ROM disc. It is however feasible with other data carriers such as a memory stick. The computer program code may furthermore be provided as pure program code on a server or a cloud and downloaded to the first communication device 121.

The memory 650 in the first communication device 121 may comprise one or more memory units and may be arranged to be used to store received information, report, measurements, data, configurations and applications to perform the method herein when being executed in the first communication device 121.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1-10. (canceled)

11. A method performed in a first communication device operating in a wireless communication network as a relay node, wherein the wireless communication network comprises a network node providing a coverage area and at least two mobile communication devices, the method comprising:
receiving a request from the network node to function as a relay node for a second communication device;
entering into a relay mode operation;
setting up a relay link comprising a first communication link between the first communication device and the network node and a second communication link between the first communication device and the second communication device;
relaying communications between the network node and the second communication device via the relay link; and wherein
in the relay mode operation, at least one of the mobility and functionality of the first communication device in a normal mode operation is controllable to prioritize the relaying function.

12. The method of claim 11, wherein to prioritize the relaying function, the method comprises any one or a combination of the following:
a) reserving resources within the first communication device to perform the relaying function;
b) releasing one or more of the other communication links;
c) releasing one or more of the other communication activities;
d) releasing one or more of data processing activities;
e) enabling specific hardware capabilities such as hardware acceleration if such capabilities exist;
f) changing beam direction;
g) adapting beam selection;
h) adapting security within the first communication device.

13. The method of claim 11, wherein the method further comprises:
monitoring a quality of the second communication link, and
informing the network node of the quality of the second communication link.

14. The method of claim 11, wherein the method further comprises:
monitoring a quality of the first communication link; and
informing the network node of the quality of the first communication link.

15. The method of claim 11, wherein the movement of the first communication device is controllable and the method comprises:
adjusting the position of the first communication device so that the quality of the first and second communication links meet a required threshold, wherein the quality threshold for the first communication link is greater than or equal to the quality threshold for the second communication link.

16. The method of claim 15, wherein adjusting the position is performed based on any one or a combination of the following:
a) instructions received from the network node;
b) information received from the second communication device;
c) stored location information;
d) predicted channel quality in the moving path of the second communication device;
e) historic data on channel quality at different positions.

17. The method of claim 15, wherein adjusting the position so that the quality of the first and second communication links meet a required threshold is performed by:
taking one unit of movement;
checking the quality of the first communication link;
adjusting the position of the first communication device if the quality of the first communication links does not meet a required threshold;
checking the quality of the second communication link;
adjusting the position of the first communication device if the quality of the second communication links does not meet a required threshold.

18. The method of claim 11, wherein the movement of the first communication device is controllable and the method comprises:
adjusting the velocity of the first communication device to avoid entering an area where the quality of the first communication link does not or will not meet a required threshold.

19. The method of claim 18, wherein adjusting the velocity is performed based on any one or a combination of the following:
a) instructions received from the network node;
b) information received from the second communication device;
c) stored location information;
d) predicted channel quality in the moving path of the second communication device;
e) historic data on channel quality at different positions.

20. The method of claim 11, further comprising:
exiting from the relay mode operation based on any one of:
a) a predefined time period that is expired;
b) an instruction received from the network node;
c) an indication received from the second communication device.
d) inability to function as a relay node anymore due to some critical functionality that will prevent the first communication device from continuing in relay mode operation.

21. A first communication device configured to operate in a wireless communication network as a relay node for a second communication device, the first communication device comprising transmitting and receiving circuitry and processing circuitry configured to:
receive a request from the network node to function as a relay node for the second communication device;
enter into a relay mode operation;
set up a relay link comprising a first communication link between the first communication device and the network node and a second communication link between the first communication device and the second communication device;
relay communications between the network node and the second communication device via the relay link; and wherein
in the relay mode operation, at least one of the mobility and functionality of the first communication device in a normal mode operation is controllable to prioritize the relaying function.

22. The first communication device of claim 21, wherein the processing circuitry is configured to prioritize the relaying function by performing any one or more of the following:
a) reserving resources within the first communication device to perform the relaying function;
b) releasing one or more of the other communication links;
c) releasing one or more of the other communication activities;
d) releasing one or more of data processing activities;
e) enabling specific hardware capabilities such as hardware acceleration if such capabilities exist;
f) changing beam direction;
g) adapting beam selection;
h) adapting security within the first communication device.

23. The first communication device of claim 21, wherein the processing circuitry is further configured to:
monitor a quality of the second communication link, and
inform the network node of the quality of the second communication link.

24. The first communication device of claim 21, wherein the processing circuitry is further configured to:
monitor a quality of the first communication link; and
inform the network node of the quality of the first communication link.

25. The first communication device of claim 21, wherein the movement of the first communication device is controllable and the processing circuitry is configured to:
adjust the position of the first communication device so that the quality of the first and second communication links meet a required threshold, wherein the quality threshold for the first communication link is greater than or equal to the quality threshold for the second communication link.

26. The first communication device of claim 25, wherein the processing circuitry is configured to adjust the position based on any one or a combination of the following:
a) instructions received from the network node;
b) information received from the second communication device;
c) stored location information;
d) predicted channel quality in the moving path of the second communication device;
e) historic data on channel quality at different positions.

27. The first communication device of claim 25, wherein the processing circuitry is configured to adjust the position so that the quality of the first and second communication links meet a required threshold by:
taking one unit of movement;
checking the quality of the first communication link;
adjusting the position of the first communication device if the quality of the first communication links does not meet a required threshold;
checking the quality of the second communication link;
adjusting the position of the first communication device if the quality of the second communication links does not meet a required threshold.

28. The first communication device of claim 21, wherein the movement of the first communication device is controllable and the processing circuitry is configured to:
adjust the velocity of the first communication device to avoid entering an area where the quality of the first communication link does not or will not meet a required threshold.

29. The first communication device of claim 28, wherein the processing circuitry is configured to adjust the velocity based on any one or a combination of the following:
a) instructions received from the network node;
b) information received from the second communication device;
c) stored location information;
d) predicted channel quality in the moving path of the second communication device;
e) historic data on channel quality at different positions.

30. The first communication device of claim 21, further comprising:
exiting from the relay mode operation based on any one of:
a) a predefined time period that is expired;
b) an instruction received from the network node;
c) an indication received from the second communication device.
d) inability to function as a relay node anymore due to some critical functionality that will prevent the first communication device from continuing in relay mode operation.
